(19) United States
(12) Patent Application Publication
(10) Pub. No.: US 2013/0217501 A1
(43) Pub. Date: Aug. 22, 2013

(54) PRESENTING APPLICATION CHALLENGES OUTSIDE AN APPLICATION EXECUTION CONTEXT

(71) Applicants: John P. Bruno, JR., Snoqualmie, WA (US); James Cain Fiduccia, Kirkland, WA (US); Brent DelFierro Dietrich, Seattle, WA (US)

(72) Inventors: John P. Bruno, JR., Snoqualmie, WA (US); James Cain Fiduccia, Kirkland, WA (US); Brent DelFierro Dietrich, Seattle, WA (US)

(73) Assignee: MICROSOFT CORPORATION, Redmond, WA (US)

(21) Appl. No.: 13/397,697

(22) Filed: Feb. 16, 2012

(51) Int. Cl. A63F 13/00; A63F 9/24

(52) U.S. Cl. 463/42; 463/43

(57) ABSTRACT

Embodiments present engagement opportunities outside an execution context of applications encouraging the engagement. A computing device accesses challenge offers each identifying a challenge for completion by a user within the execution context of an application. Without causing the application to be executed, the challenge offers are presented to the user. After receiving a request from the user to participate in one of the challenges, the computing device directs execution of the corresponding application to present the challenge. In some embodiments, challenge participation statistics from a plurality of users are aggregated and provided to potential challenge sponsors.

### BACKGROUND

Some existing online gaming services and systems present challenges to users that execute the games. For example, users execute games and navigate to a submenu of the executing game to see daily and weekly challenges. With these systems, the users have to know that the challenges exist, execute the games, and then deliberately seek the challenges.

Further, some of the existing systems enable person-to-person challenges. In such systems, one of the users challenges another player by sending a notification to the other player. These systems fail to engage the broader gaming community available in the gaming service.

### SUMMARY

Embodiments of the disclosure encourage execution of applications by presenting challenge offers outside the context of the applications. A computing device accesses a plurality of the challenge offers. Each of the challenge offers is associated with a challenge for completion by a user within a context of the executing application. Without causing the application to be executed, the computing device presents the accessed plurality of challenge offers to the user. The computing device receives a request from the user to participate in at least one of the presented challenge offers. The computing device directs, in response to the received request, execution of the application associated with the challenge offer accepted by the user to present the challenge.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating communication between computing devices and a web service to implement challenge campaigns.

FIG. 2 is an exemplary block diagram illustrating a computing device for administering challenges to users.

FIG. 3 is an exemplary flow chart illustrating operation of a computing device to present challenge offers to users and execute corresponding applications to present challenges.

FIG. 4 is an exemplary flow chart illustrating operation of a computing device to generate personalized challenge participation statistics to entice users to participate in challenges.

FIG. 5 is an exemplary block diagram illustrating a data store having computer-executable components for administering challenges to users.

FIG. 6 is an exemplary block diagram illustrating an infrastructure for managing a challenge campaign.

FIG. 7 is an exemplary block diagram illustrating a community challenges screen for the out-of-game presentation of challenge offers to users.

FIG. 8A is an exemplary diagram of a user viewing challenge offers out-of-game.

FIG. 8B is an exemplary diagram of a user accepting a presented challenge offer.

FIG. 8C is an exemplary diagram of a user participating in an accepted challenge offer.

FIG. 8D is an exemplary diagram of a user viewing challenge completion statistics for the user and for contacts of the user.

Corresponding reference characters indicate corresponding parts throughout the drawings.

### DETAILED DESCRIPTION

Referring to the figures, embodiments of the disclosure present challenge offers 104 or other engagement opportunities outside an execution context of applications 206 associated with the challenge offers 104. The challenge offers 104 encourage users 108 to engage in the applications 206 by describing challenges available within the execution context of the applications 206. As such, aspects of the disclosure promote the discovery of content by the users 108, encourage the users 108 to engage in the applications 206, and allow content providers (e.g., application developers) to interact with an entire population or community of the users 108.

In some embodiments, the challenge offers 104 are presented to the user 108 on a home screen, start screen, dashboard, or other user interface on any device without executing the applications 206 associated with the challenge offers 104. Such out-of-application challenge offer presentation is applicable to any challenges, including challenges in which achievements are awardable (e.g., unlocked) only upon participation by a pre-defined community of the users 108 (e.g., quantity or type of the users 108). In addition to presenting the challenge offers 104, aspects of the disclosure present out-of-application data such as aggregated challenge participation statistics 212, personalized challenge participation statistics 214, and/or other notifications, as described herein. Some embodiments help the users 108 discover opportunities to compete with friends or other contacts in games, regardless of whether the friends are online at the same time. Aspects of the disclosure, however, are applicable to any application 206.

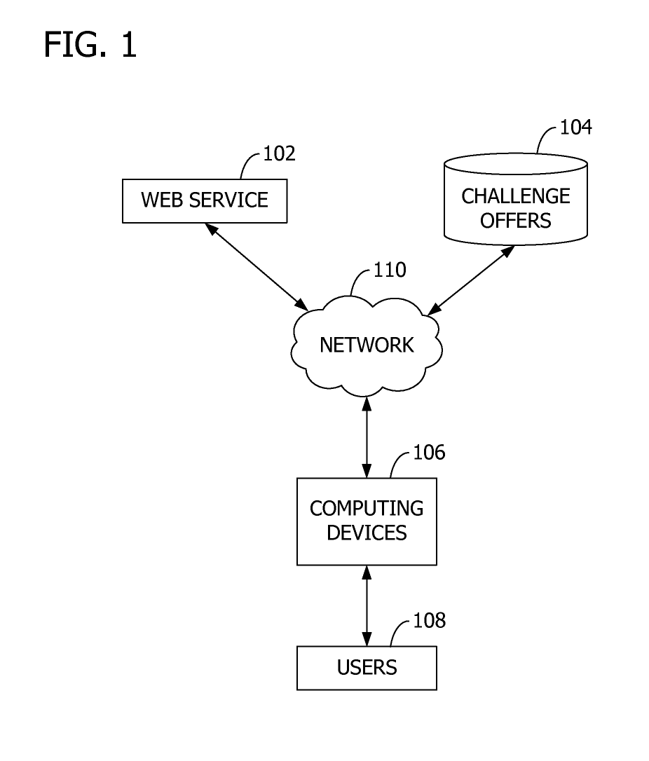

Referring next to FIG. 1, an exemplary block diagram illustrates communication between computing devices 106 and at least one web service 102 to implement challenge campaigns. In the example of FIG. 1, each of one or more users 108 operates one or more of the computing devices 106. For example, each of the users 108 may have a tablet, laptop, mobile telephone, portable media player, and/or gaming console. One or more of the computing devices 106 communicate with the web service 102 via at least one network 110 such as the Internet. Aspects of the disclosure, however, are operable with intranets, extranets, cellular networks, Wi-Fi networks, or any other network or combination thereof.

The web service 102 represents any functionality for creating, storing, implementing, and otherwise administering challenge campaigns. While aspects of the disclosure describe the web service 102 with reference to a gaming service, embodiments of the disclosure are operable with any web service 102. For example, the web service 102 is not limited to games, but may be associated with encouraging users 108 to perform any desired behavior such as executing any applications 206 (e.g., word processing, financial, or scientific), visiting any web site, performing any search query, purchasing any product or service, and the like.

Further, at least a portion of the functionality of the web service 102 may be embodied in the computing devices 106. For example, one or more of the computing devices 106 may execute to provide the functionality provided by the web service 102.

In some embodiments, the challenge campaigns represent any offer, advertisement, enticement, or the like that encourages the users 108 to perform a desired behavior, such as execute one of the applications 206 to participate in a challenge. The challenge campaigns may be defined by the web service 102, application developers, and/or challenge sponsors or advertisers. Each of the challenge campaigns includes one or more challenge offers 104 or other engagement opportunities. The challenge offers 104 are accessible to the web service 102 and the computing devices 106 via the network 110. Exemplary challenges are time-based and/or goal-based.

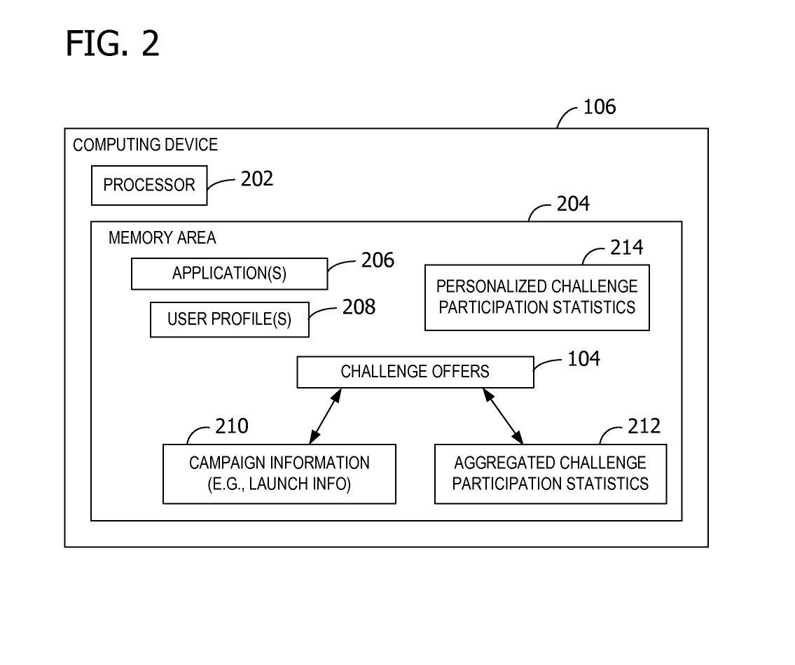

Referring next to FIG. 2, an exemplary block diagram illustrates one of the computing devices 106 for administering challenges to users 108. While aspects of the disclosure describe the computing device 106 as being associated with the user 108, the computing device 106 (or portions thereof), may be associated with the web service 102 or other entity.

In the example of FIG. 2, the computing device 106 is part of a system for enticing the user 108 to execute a game or other application 206 by presenting at least one of the challenge offers 104. In some embodiments, the computing device 106 is associated with the user 108. In other embodiments, the computing device 106 is associated with the web service 102 or other entity other than the user 108.

The computing device 106 represents any device executing instructions (e.g., as application programs, operating system functionality, or both) to implement the operations and functionality associated with the computing device 106. The computing device 106 may include a mobile computing device or any other portable device. In some embodiments, the mobile computing device includes a mobile telephone, laptop, tablet, television, computing pad, netbook, gaming device or console, and/or portable media player. The computing device 106 may also include less portable devices such as desktop personal computers, kiosks, and tabletop devices. Additionally, the computing device 106 may represent a group of processing units or other computing devices.

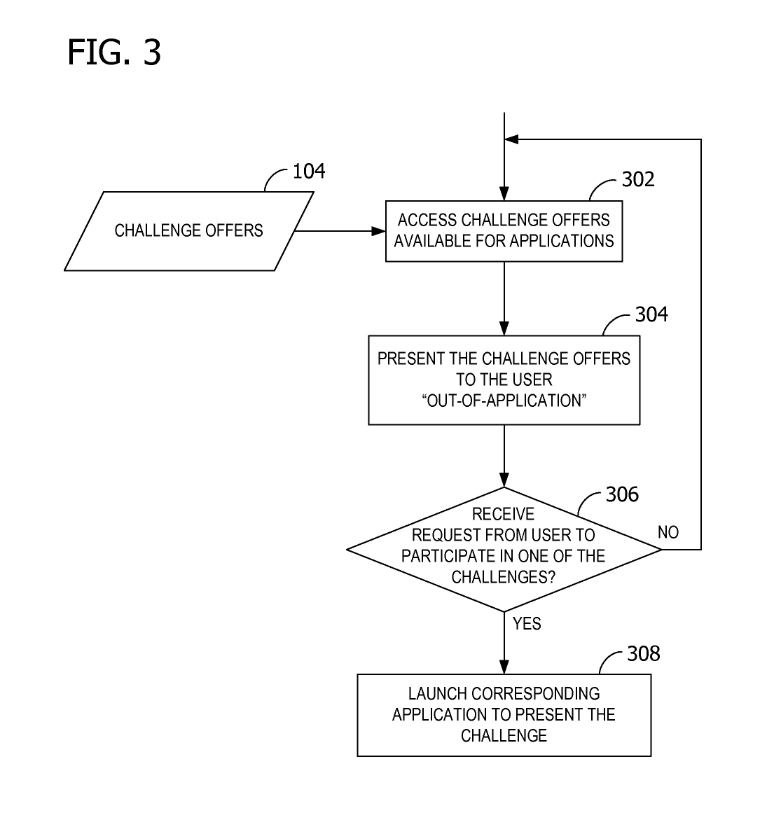

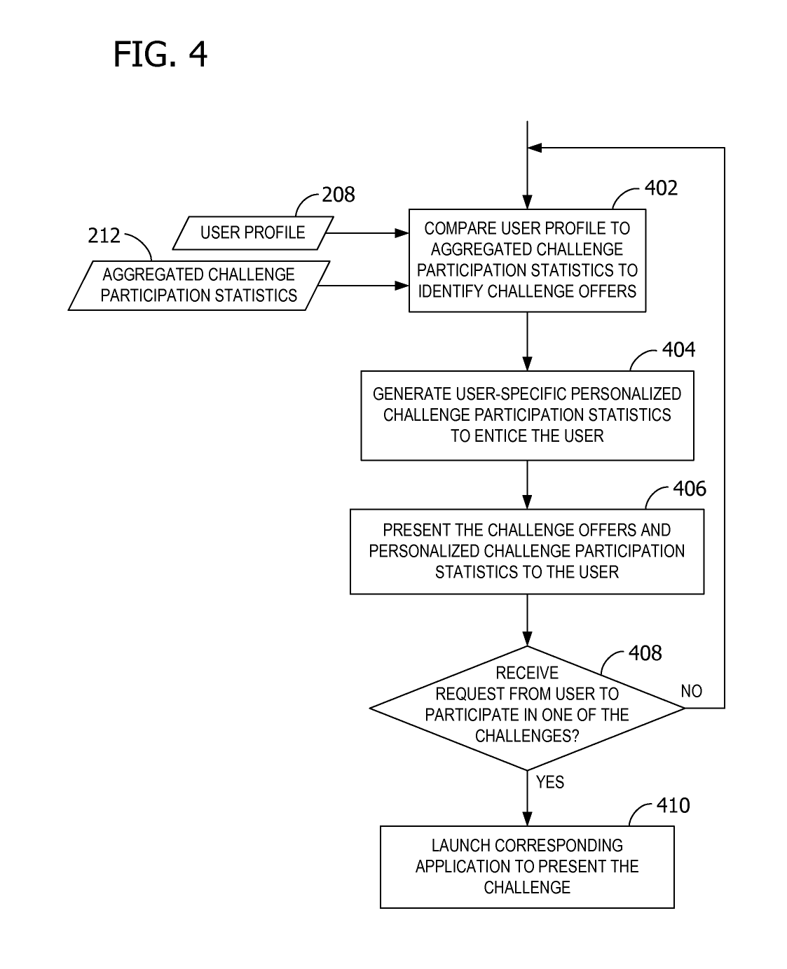

The computing device 106 has at least one processor 202 and a memory area 204. The processor 202 includes any quantity of processing units, and is programmed to execute computer-executable instructions for implementing aspects of the disclosure. The instructions may be performed by the processor 202 or by multiple processors executing within the computing device 106, or performed by a processor external to the computing device 106. In some embodiments, the processor 202 is programmed to execute instructions such as those illustrated in the figures (e.g., FIG. 3 and/or FIG. 4).

The computing device 106 further has one or more computer readable media such as the memory area 204. The memory area 204 includes any quantity of media associated with or accessible by the computing device 106. The memory area 204 may be internal to the computing device 106 (as shown in FIG. 2), external to the computing device 106 (not shown), or both (not shown).

The memory area 204 stores, among other data, one or more of the applications 206. The applications 206, when executed by the processor 202, operate to perform functionality on the computing device 106. Exemplary applications 206 include mail application programs, web browsers, calendar application programs, address book application programs, messaging programs, media applications, location-based services, search programs, and the like. The applications 206 may communicate with counterpart applications or services such as web services 102 accessible via the network 110. For example, the applications 206 may represent downloaded client-side applications that correspond to server-side services executing in a cloud.

The memory area 204 further stores one or more user profiles 208. The user profiles 208 include, but are not limited to, one or more of the following: user activity history (e.g., interactions with the computing devices 106), purchasing behavior, purchase history, browsing behavior and history, and user preferences. For example, each of the user profiles 208 may identify one or more of the following: games played by the user 108, applications 206 executed by the user 108, friends of the user 108, contacts of the user 108, game achievements of the user 108, user demographics, user employment, and a challenge participation history of the user 108.

The memory area 204 also stores one or more of the challenge offers 104. Each of the challenge offers 104 has campaign information 210 associated therewith. The campaign information 210 includes, but is not limited to, information about the application 206 associated with the challenge, the sponsor of the challenge, the challenge itself (e.g., what is the challenge), the leaderboards, community activity surrounding the challenge, the opportunity to join or accept the challenge, and/or the criteria for earning or winning a reward by participating in the challenge. The campaign information 210 further includes launch information for use when executing the application 206 to present the challenge in response to a request from the user 108 accepting the challenge.

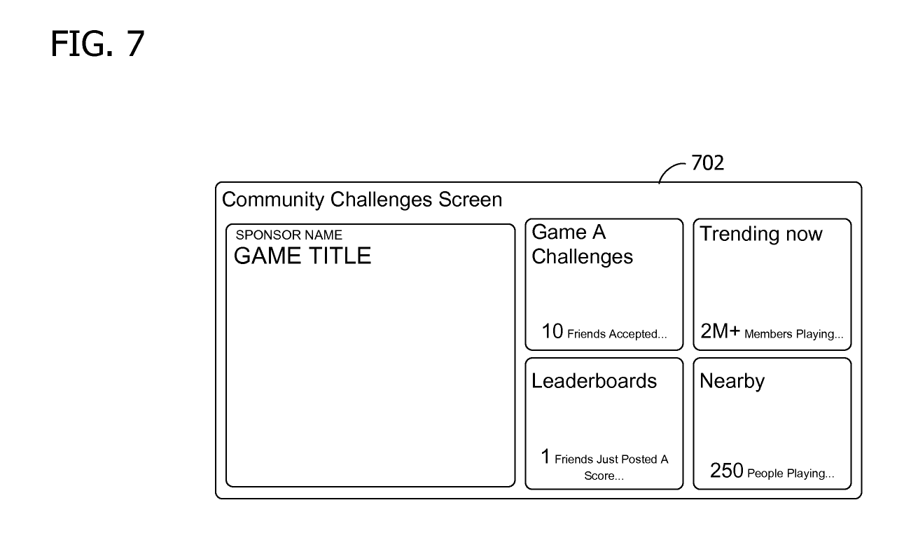

Each of the challenge offers 104 further has aggregated challenge participation statistics 212. The aggregated challenge participation statistics 212 describe or reflect participation in the challenge offer 104 by a plurality of the users 108 (e.g., a community of users 108). Exemplary aggregated challenge participation statistics 212 include, but are not limited to, the quantity of users 108 who have participated in the challenge, the quantity of users 108 who have completed the challenge successfully (e.g., to win a reward), and/or the quantity of users 108 who failed to complete the successfully (e.g., finished the challenge without earning a reward). Alternatively or in addition, the aggregated challenge participation statistics 212 may be represented by percentages (e.g., percentage of users 108 who successfully completed the challenge). The aggregated challenge participation statistics 212 are capable of access out-of-game such that leaderboards may be generated and provided for display (e.g., see FIG. 7).

Further, any of the aggregated challenge participation statistics 212 may be filtered, sorted, grouped, or otherwise rearranged to generated personalized challenge participation statistics 214 from the aggregated challenge participation statistics 212. For example, the aggregated challenge participation statistics 212 may be filtered by a location of the user 108 to present challenge participation statistics for only the community of users 108 local to a particular user 108 (e.g., within a particular geographic area). The aggregated challenge participation statistics 212 may also be filtered to present the aggregated statistics associated with friends or contacts of the user 108.

The computing device 106 may further a network interface card and/or computer-executable instructions (e.g., a driver) for operating the network interface card (not shown).

The computing device 106 may further include a user interface for displaying data to the user 108 and receiving data from the user 108. The user interface includes any display (e.g., a touch screen display) and/or computer-executable instructions (e.g., a driver) for operating the display. For example, the user interface may be supported by a graphics card and computer-executable instructions (e.g., a driver) for operating the graphics card. The user interface represents one or more of the following to provide data to the user 108 and/or receive data from the user 108: speakers, a sound card, a camera, a microphone, a vibration motor, one or more accelerometers, a BLUETOOTH brand communication module, global positioning system (GPS) hardware, and a photoreceptive light sensor. For example, the user 108 may input commands or manipulate data by moving the computing device 106 in a particular way.

Referring next to FIG. 3, an exemplary flow chart illustrates operation of the computing device 106 to present challenge offers 104 to users 108 and execute corresponding applications 206 to present challenges. While the operations illustrated in FIG. 3 are described as being executed by the computing device 106 in some embodiments, one or more of the operations may be performed by the web service 102 or other entity in other embodiments.

At 302, the computing device 106 accesses a plurality of the challenge offers 104. For example, the challenge offers 104 may be obtained by the computing device 106 from the web service 102 (or other entity). Each of the challenge offers 104 is associated with a challenge for completion by the user 108 within the context of at least one of the applications 206 to be executed. The challenge offers 104 may be associated with any challenge including, but not limited to, community challenges, individual user challenges, user-to-user challenges, and/or challenges for which rewards are provided only after a pre-determined quantity of the users 108 participates in the challenges.

At 304, the computing device 106 presents the challenge offers 104 to the user 108 “out-of-application.” In particular, the challenge offers 104 are presented outside an execution environment of the application 206, such as in a community challenges area separate from the application 206. In some embodiments, presenting the challenge offers 104 outside the execution environment includes presenting the challenge offers 104 without causing the application 206 to be executed. For example, the challenge offers 104 may be presented in a user interface associated with a start screen, home screen, dashboard, bootup menu, browser (e.g., to display a web page such as from a social networking web site), an electronic mail message, a text message, a voice mail message, and a microblog post.

If a request is received from the user 108 to participate in or accept one of the presented challenge offers 104 at 306 (e.g., the computing device 106 receives an acceptance from the user 108), the computing device 106 directs execution of the application 206 associated with the accepted challenge offer 104 to present the challenge. For example, the computing device 106 executes or launches the application 206 associated with the accepted challenge offer 104 to present the challenge at 308.

In some embodiments, directing execution of the application 206 includes selecting a user device on which to execute the application 206. For example, if the challenge offers 104 are presented in a web page, the computing device 106 may select a gaming console, mobile telephone, or laptop of the user 108 to present the challenge. The selection is based on the accepted challenge offer 104 (e.g., some challenge offers 104 may be designed for presentation on particular devices), a preference of the user 108 (e.g., the device specified by the user 108), or other factor or criteria.

The participation by the user 108 in the challenge may unlock rewards or other incentives or achievements. In some embodiments, the level of participation and completion by the user 108 affects the type, status, and/or quantity of reward. The rewards may be administered by the author of the challenge (e.g., the developer of the challenge offer 104), a sponsor of the challenge, or another entity such as a rewards system provider.

The computing device 106 may further collect challenge participation statistics regarding participation by the user 108 in the accepted challenge. The collected challenge participation statistics may also be crowdsourced or otherwise added to the challenge participation statistics of other users 108 to create or update the aggregated challenge participation statistics 212.

Referring next to FIG. 4, an exemplary flow chart illustrates operation of the computing device 106 to generate personalized challenge participation statistics 214 to entice users 108 to participate in challenges. While the operations illustrated in FIG. 4 are described as being executed by the computing device 106 in some embodiments, one or more of the operations may be performed by the web service 102 or other entity in other embodiments.

The computing device 106 accesses the user profile 208 for a particular user 108 and the aggregated challenge participation statistics 212 (e.g., stored in the memory area 204). At 402, the computing device 106 compares the user profile 208 to the aggregated challenge participation statistics 212 to identify one or more of the challenge offers 104 to present to the user 108. For example, the aggregated challenge participation statistics 212 may be filtered to identify the challenge offers 104 associated with applications 206 available for execution on the computing device 106 (or other devices of the user 108), applications 206 identified as favorites by the user 108, applications 206 not recently executed by the user 108, etc. Different challenge offers 104 and different challenges may be available for each of the different computing devices 106 of the user 108. The computing device 106 may also identify the challenge offers 104 that have been accepted by friends or contacts of the user 108.

At 404, the computing device 106 generates user-specific, personalized challenge participation statistics 214 to entice the user 108 to accept or otherwise participate in at least one of the identified challenge offers 104. In some embodiments, the computing device 106 filters the aggregated challenge participation statistics 212 associated with the identified challenge offers 104 to compile the set of personalized challenge participation statistics 214 associated with friends and/or contacts of the user 108. For example, the computing device 106 generates a leaderboard showing challenge participation statistics associated only with friends of the user 108. The leaderboard may identify one or more contacts of the user 108 who have participated in at least one of the identified plurality of challenge offers 104. For example, realizing that ten friends have participated in one of the challenge offers 104, the user 108 is motivated to also participate in the same challenge offer 104.

At 406, the computing device 106 presents, displays, or provides for display, the identified challenge offers 104 and the personalized challenge participation statistics 214 to the user 108. The identified challenge offers 104 are presented out-of-application (e.g., outside the context or execution environment of the application 206 associated with the challenge offer 104). For example, the computing device 106 presents the identified challenge offers 104 without executing a game associated with the accepted challenge offer 104.

If the computing device 106 receives a request from the user 108 at 408 to participate in one of the presented challenge offers 104, the computing device 106 executes or otherwise launches the corresponding application 206 at 410 to present the challenge associated with the accepted challenge offer 104.

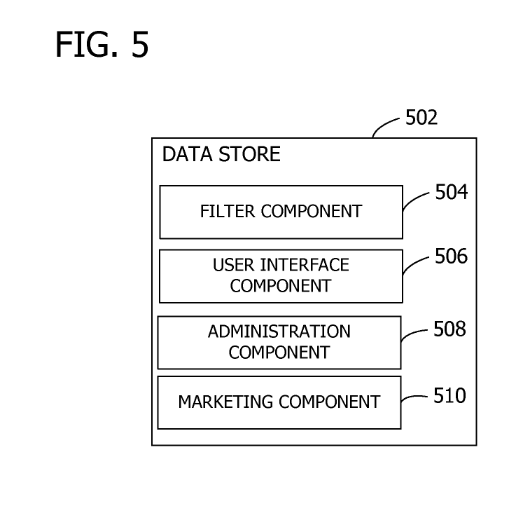

Referring next to FIG. 5, an exemplary block diagram illustrates a data store 502 having computer-executable components for administering challenges to users 108. While the data store 502 is described in some embodiments as being associated with the computing device 106, one or more elements of the data store 502 may be associated with the web service 102 (e.g., an online gaming service) or other entity. For example, one or more of the computer-executable components illustrated in FIG. 5 may be executed by the computing device 106, the web service 102, or other entity.

The data store 502 provides access to one or more computer-executable components. Exemplary components include a filter component 504, a user interface component 506, an administration component 508, and a marketing component 510. The filter component 504, when executed by a processor accessing the data store 502, causes the processor to select a plurality of the challenge offers 104 for each of a plurality of the users 108. The filter component 504 selects the plurality of challenge offers 104 for each of the plurality of users 108 based on user profiles 208 of the plurality of users 108, personalized challenge participation statistics 214, and/or applications 206 available for execution by the users 108, among other factors.

The user interface component 506, when executed by a processor accessing the data store 502, causes the processor to present, without causing the corresponding applications 206 to be executed, the plurality of challenge offers 104 selected by the filter component 504 to the plurality of users 108. For example, the plurality of challenge offers 104 is presented in a user interface not associated with the corresponding applications 206. In some embodiments, however, at least one of the challenge offers 104 associated with one application (e.g., a first application) may be presented within the context of a different, other application (e.g., a second application). The user interface component 506 further receives a request from at least one of the plurality of users 108 to participate in one or more of the presented plurality of challenge offers 104.

The administration component 508, when executed by a processor accessing the data store 502, causes the processor to initiate execution of the application 206 associated with the received request to present the challenge associated with the challenge offer 104 accepted by the user 108. In some embodiments, the web service 102 administers a plurality of challenges requested by a plurality of the users 108.

The marketing component 510, when executed by a processor accessing the data store 502, causes the processor to generate challenge participation statistics from the presented challenges. For example, the user interface component 506 provides the challenge participation statistics generated by the marketing component 510 for review by potential challenge sponsors to encourage challenge sponsorship.

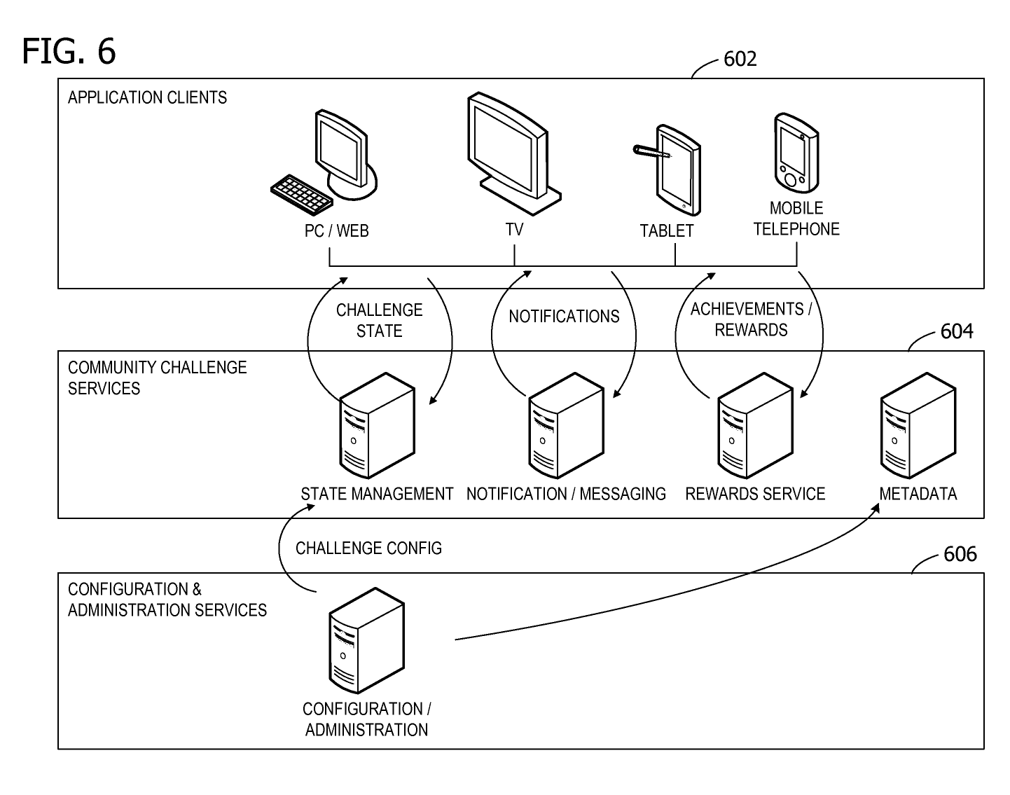

Referring next to FIG. 6, an exemplary block diagram illustrates an infrastructure for managing a challenge campaign. The organization and functionality of the elements in FIG. 6 is merely exemplary, and other organizations and divisions of functionality are contemplated.

In the example of FIG. 6, the system includes application clients 602, community challenge services 604, and configuration and administration services 606. The application clients 602 include, but are not limited to, a personal computer or other web interface, a television, a tablet, or a mobile telephone. The community challenge services 604 include, but are not limited to, a state management service, a notification or messaging service, a rewards service, and a metadata service. The state management service provides community challenge state management to the application clients 602. State management includes managing the lifecycle, state, mechanics, and statistics associated with the challenges and challenge offers 104.

The notification or messaging service enables notifications (e.g., of challenge offers 104) to be sent to the users 108 out-of-application. In some embodiments, the challenge offers 104 are provided via a “skinnable” application that executes to present the challenge offers 104 out-of-application, or otherwise outside the execution context of the application 206 to encourage the user 108 to execute the application 206. Text and art corresponding to the challenge offers 104 and/or the challenge sponsors (e.g., logos or skins) are also provided by the notification or messaging service. The notifications or messages may also include sponsorship information (e.g., which sponsor is supporting which challenge offer 104) and aggregated challenge participation statistics 212. For example, the aggregated challenge participation statistics 212 may be presented in a leaderboard.

The notifications that include challenge offers 104 may be presented as messages capable of being selected by the user 108. Each of the messages represents a strongly-typed message that allows data payloads to be attached that contain information about the application state being targeted (e.g., launch or execution information such as game activation codes). When the user 108 selects one of the presented challenge offers 104 via the messages (e.g., the user 108 clicks on one of the messages), the computing device 106 launches the corresponding application 206 and uses the payload to determine the application parameters and values to set to present the challenge. While shown as separate from the state management service in FIG. 6, the notification or messaging service may be leveraged as part of the state management service.

The rewards service enables achievements to be awarded for community gameplay and challenges. The metadata service enables challenges to be described (e.g., for presentation as challenge offers 104) and for campaign information 210 to be stored (e.g., application name, identifier, and/or title, challenge text descriptions, logos, termination conditions, theme, etc.).

The configuration and administration services 606 are used by application developers, sponsors, or other entities to create and manage community challenge attributes such as duration, invitations, and the like.

In some embodiments, a preference service (not shown) allows each of the users 108 to define preferences describing the type, quantity, properties, or other aspects of the available challenge offers 104. For example, the preference service stores the define preferences as part of the user profile 208.

Referring next to FIG. 7, an exemplary block diagram illustrates a community challenges screen 702 for the out-of-game presentation of challenge offers 104 to users 108. The community challenges screen 702 is presented to the user 108 via a user interface. The user interface may be associated with any computing device 106 not limited to those devices described herein. The user interface is presented on a home page, start page, dashboard, or the like that is outside the context of execution of the application 206 in which the challenges will be played by the user 108.

Additionally, while described with reference to challenge offers 104 associated with a game, aspects of the disclosure are operable with challenge offers 104 associated with any behavior desired from the user 108. For example, the community challenges screen 702 may present statistics or a summary of the audio and/or video content consumed by each friend or contact of the user 108. In this manner, aspects of the disclosure promote the discovery of content by the user 108.

The exemplary community challenges screen 702 includes a plurality of portions for displaying information associated with one or more challenge offers 104 associated with Game A. The displayed information is pulled or derived from the campaign information 210, the aggregated challenge participation statistics 212, the personalized challenge participation statistics 214, and/or other data. For example, the community challenges screen 702 displays a game title (e.g., including a sponsor name or other identification of the sponsor of the challenge), the challenge offers 104 associated with the game title (e.g., Game A Challenges), Leaderboards, Trending Now data, and Nearby users 108 who are currently participating in one or more of the challenge offers 104. In the example of FIG. 7, ten friends of the user 108 have accepted at least one of the Game A Challenges, two million plus members are playing the Game A Challenges, one friend of the user 108 just posted a score to the Leaderboards (e.g., completed one of the Game A Challenges), and 250 nearby people are participating in at least one of the Game A Challenges.

In this manner, the user 108 is presented with information that encourages the user 108 to engage with Game A (e.g., to execute the game title).

The user 108 may interact with the community challenges screen 702 to obtain additional information. For example, the user 108 may drill-down into the aggregated challenge participation statistics 212 presented in the Leaderboards to identify the statistics associated with a particular user 108 (e.g., gameplay status). The user 108 may use any pointing device (e.g., controller, mouse, etc.) or gestures to interact with the community challenges screen 702.

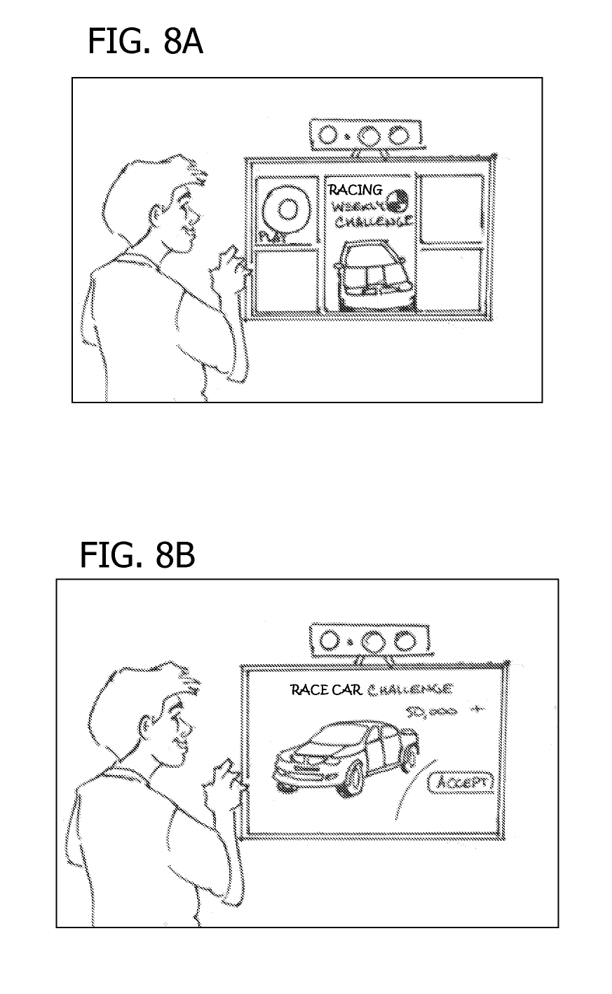

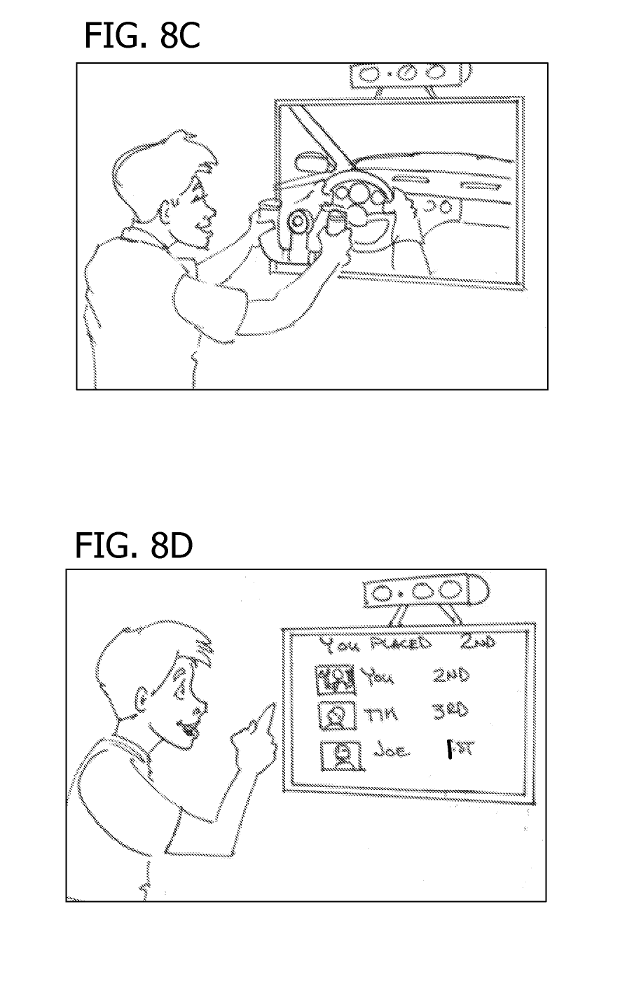

Referring next to FIG. 8A, FIG. 8B, FIG. 8C, and FIG. 8D, exemplary diagrams illustrate a user 108 interacting with a user interface to view a challenge offer out-of-game, accept the challenge offer, participate in the challenge associated with the challenge offer, and view leaderboard results upon completing the challenge. As an example, the user 108 may have logged into play a first person shooter game. In FIG. 8A, before executing the first person shooter game, the user 108 views a home screen or other out-of-game application that presents information about the challenge offer associated with a racing game. The home screen in this example is divided into a plurality of slots or portions for presenting several challenge offers. The presented application may identify the game, the sponsor, the challenge, the leaderboards, community activity surrounding the challenge offer, and the opportunity to accept the challenge offer and join the challenge in an attempt to win the reward. In some embodiments, the challenge offer is presented within a skinned banner advertisement (e.g., with logos or other sponsor information).

The user 108 selects (e.g., via a controller, motion sensing user interface, or other communication means) the presented challenge offer associated with the racing game to learn more about the challenge offer.

In FIG. 8B, the user 108 is presented with additional information about the selected challenge offer. The additional information includes the campaign information 210 including rewards and requirements of the challenge offer. In the example of FIG. 7, the user 108 notices that for a limited time, a premier sports car manufacturer has teamed up with the racing game to sponsor a speedway challenge. Participants who rank in the top three positions against online opponents win an exclusive car pack. The user 108 also notices in the aggregated challenge participation statistics 212 that over 50,000 people have already accepted the challenge, and that the quantity of participants is trending upwards.

The user 108 accepts the challenge offer by interacting with the user interface. The computing device executes the racing game to present the challenge.

In FIG. 8C, the user 108 participates in the challenge. In this example, the user 108 drives a car in the racing game. After completing the race, the user 108 is presented with a leaderboard as shown in FIG. 8D. In this example, the leaderboard indicates that the user 108 has placed second in the race (e.g., is eligible for the reward), and displays the participation statistics of several friends of the user 108. The reward unlocks a new car pack for use in the racing game, and the user 108 proceeds to abandon the attempt to play the first person shooter game and continue to play the racing game to try out the newly unlocked cars.

### Additional Examples

Aspects of the disclosure are operable with synchronous gameplay and/or asynchronous gameplay. In synchronous gameplay, the users 108 generally play simultaneously against each other online. In contrast, asynchronous gaming represents a class of gameplay that allows the users 108 to play together simultaneously when online, but also allows each user 108 to go offline and resume gameplay later. In some embodiments, asynchronous gameplay involves completely offline scenarios where users 108 play together offline and never be online at the same time.

There are many examples of asynchronous gameplay. For example, racing games that allow the user 108 to race against another user's ghost provide users 108 with the ability to play together even though they are not online at the same time. Further, turn-based games allow the users 108 to take turns in board or card games despite not being online together. In general, asynchronous gameplay facilitates gameplay with users 108 who are not simultaneously joined together in a session.

In asynchronous gameplay scenarios, the memory area 204 and processor 202 are associated with an asynchronous gaming service.

At least a portion of the functionality of the various elements in FIG. 1, FIG. 2, and FIG. 5 may be performed by other elements in FIG. 1, FIG. 2, or FIG. 5, or an entity (e.g., processor, web service, server, application program, computing device, etc.) not shown in FIG. 1, FIG. 2, or FIG. 5.

In some embodiments, the operations illustrated in FIG. 3 and FIG. 4 may be implemented as software instructions encoded on a computer readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users 108. In such embodiments, notice is provided to the users 108 of the collection of the data (e.g., via a dialog box or preference setting) and users 108 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible, exclude propagated data signals, and are mutually exclusive to communication media. In some embodiments, computer storage media are implemented in hardware. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, embodiments of the invention are operational with numerous other general purpose or special purpose computing system environments or configurations. Examples of well-known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for enticing the user 108 to execute the game by presenting the challenges out-of-game, and exemplary means for encouraging challenge sponsorship by presenting the aggregated challenge participation statistics 212.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for enticing a user to execute a game to participate in a challenge, said system comprising:
a memory area associated with a computing device, said memory area storing a plurality of challenge offers each associated with a game and each having aggregated challenge participation statistics associated therewith, said memory area further storing at least one user profile; and
a processor programmed to:
compare the user profile stored in the memory area to one or more of the aggregated challenge participation statistics stored in the memory area to identify one or more of the plurality of challenge offers;
generate personalized challenge participation statistics based on the user profile and the aggregated challenge participation statistics associated with the identified challenge offers;
present the identified challenge offers with the generated, personalized challenge participation statistics to a user associated with the user profile;
receive an acceptance from the user of at least one of the presented challenge offers; and
execute the game associated with the accepted challenge offer to present a challenge for completion by the user.

2. The system of claim 1, wherein the processor is programmed to present the identified challenge offers by presenting the identified challenge offers outside a context of the game.

3. The system of claim 1, wherein the processor is programmed to present the identified challenge offers by presenting the identified challenge offers without executing the game.

4. The system of claim 1, wherein the computing device comprises one or more of the following: a gaming console, a mobile telephone, a tablet, a portable media player, and a television.

5. The system of claim 1, wherein the user profile identifies one or more of the following: games played by the user, applications executed by the user, friends of the user, contacts of the user, user preferences, a browsing history of the user, a purchase history of the user, game achievements of the user, and a challenge participation history of the user.

6. The system of claim 1, wherein the processor is programmed to generate the personalized challenge participation statistics by identifying one or more contacts of the user who have participated in at least one of the identified plurality of challenge offers.

7. The system of claim 1, wherein the memory area and the processor are associated with a web service, and wherein the processor is further programmed to present the aggregated challenge participation statistics to a potential challenge sponsor to encourage the potential challenge sponsor to sponsor a challenge.

8. The system of claim 1, wherein the memory area and the processor are associated with an asynchronous gaming service.

9. The system of claim 1, further comprising means for enticing the user to execute the game by presenting the challenges out-of-game.

10. The system of claim 1, further comprising means for encouraging challenge sponsorship by presenting the aggregated challenge participation statistics.

11. A method comprising:
accessing, by a computing device, a plurality of challenge offers each associated with a challenge, said challenge for completion by a user within a context of an executing application;
presenting, without causing the application to be executed, the accessed plurality of challenge offers to the user;
receiving, by the computing device, a request from the user to participate in at least one of the presented challenge offers; and
directing, in response to the received request, execution of the application associated with the at least one of the presented challenge offers to present the challenge associated therewith.

12. The method of claim 11, further comprising generating aggregated challenge participation statistics reflecting participation in the challenges by a plurality of users.

13. The method of claim 11, wherein directing execution of the application comprises selecting a user device on which to execute the application.

14. The method of claim 13, wherein selecting a user device comprises selecting one or more of the following: a gaming console, a mobile telephone, a tablet, a portable media player, and a television.

15. The method of claim 11, wherein presenting the accessed plurality of challenges comprises providing the accessed plurality of challenges via one or more of the following: a social networking web site, an electronic mail message, a text message, a voice mail message, and a microblog post.

16. The method of claim 11, wherein presenting the accessed plurality of challenges comprises displaying the accessed plurality of challenges on a home screen of a gaming console.

17. The method of claim 11, wherein accessing the plurality of challenge offers comprises accessing one or more of the following: a plurality of community challenges, individual user challenges, user-to-user challenges, and challenges for which rewards are provided only after a pre-determined quantity of the users participates in the challenges.

18. One or more computer storage media embodying computer-executable components, said components comprising:
a filter component that when executed causes at least one processor to select a plurality of challenge offers for each of a plurality of users, each of the plurality of challenge offers being associated with a challenge for completion by a user within a context of an executing application;
a user interface component that when executed causes at least one processor to present, without causing the application to be executed, the plurality of challenge offers selected by the filter component to the plurality of users, the user interface component further receiving requests from the plurality of users to participate in one or more of the presented plurality of challenge offers;
an administration component that when executed causes at least one processor to initiate execution of the applications associated with the one or more of the presented plurality of challenge offers in response to the requests received by the user interface component, wherein the applications execute to present the challenges associated therewith; and
a marketing component that when executed causes at least one processor to generate challenge participation statistics from the presented challenges, the user interface component providing the challenge participation statistics generated by the marketing component for review to encourage challenge sponsorship.

19. The computer storage media of claim 18, wherein the user interface component provides the challenge participation statistics generated by the marketing component for review by potential sponsors.

20. The computer storage media of claim 18, wherein the filter component selects the plurality of challenge offers for each of the plurality of users based on user profiles of the plurality of users and on personalized challenge participation statistics.
